(19) United States
(12) Patent Application Publication
(10) Pub. No.: US 2026/0268371 A1
(43) Pub. Date: Sep. 10, 2026

(54) SYSTEMS AND METHODS FOR PREDICTION OF USER INTEREST IN SERVICES BASED ON TELECOMMUNICATIONS DATA

(71) Applicant: IVT Communications FZC LLC, Ajman Media City (AE)

(72) Inventors: Ivan Tikhonov, Dubai (AE); Aleksandr Moskotin, Dubai (AE)

(21) Appl. No.: 19/075,332

(22) Filed: Mar. 10, 2025

(51) Int. Cl. G06Q 30/0251

(52) U.S. Cl. CPC G06Q 30/0255

(57) ABSTRACT

Systems and methods implement a platform for analyzing telecom-specific data sources including boosted ensemble machine learning and deep neural networks to determine user interest in various services. The system dynamically processes telecom logs, including SMS logs, call logs, push notifications, email interactions, and domain visit patterns to predict user interest in services. A multi-stage ensemble architecture refines predictions, optimizing engagement timing through real-time behavioral shifts and contextual clustering, providing targeted and timely service recommendations.

### TECHNICAL FIELD

Embodiments relate to machine learning. More particularly, embodiments relate to boosted ensemble models for prediction of user interest.

### BACKGROUND

Predicting user interest in services based on behavioral data presents significant challenges. Many existing systems rely on predefined rules, static segmentation, or basic machine learning models that primarily analyze clickstream data and browsing history. These methods often fail to account for complex behavioral patterns, leading to inaccurate predictions and irrelevant recommendations. Furthermore, existing systems typically lack real-time adaptability, relying on batch-processed historical data that does not reflect recent user interactions or shifting preferences.

Telecommunications networks generate extensive user activity data, including domain visits, SMS interactions, and call records. This data provides a more detailed view of user behavior beyond website activity, offering additional context for predicting interest in services. However, integrating such diverse data sources into predictive models remains a technical challenge. Existing approaches do not effectively combine real-time telecom activity with behavioral trends, limiting their ability to generate accurate and timely predictions. Existing approaches further do not effectively combine real-time telecom activity with behavioral trends, limiting their ability to generate accurate and timely predictions.

Traditional machine learning models used for user interest prediction often operate as black-box systems with limited adaptability. Many do not dynamically adjust their predictions based on new user behavior, making it difficult to detect contextual shifts or evolving preferences. Additionally, scaling these models to process continuous streams of telecom data in real-time presents computational and efficiency constraints. A more flexible and responsive system is needed to process large-scale user data while continuously updating predictions as new information becomes available.

Therefore, there is a need for an improved platform to determine user interest in services and optimize engagement timing through real-time behavioral analysis.

### SUMMARY

Embodiments substantially meet the aforementioned needs of the industry. Systems and methods implement a platform including boosted ensemble machine learning and deep neural networks to determine user interest in various services and optimize engagement timing based on real-time behavioral analysis. In an embodiment, services can include financial services, business services, marketing services, or any other service that supports a user goal.

Systems and methods predict user interest in predefined thematic categories, and further can refine engagement strategies by identifying optimal engagement timing based on real-time behavioral analysis. Instead of solely predicting product interest, embodiments distinguish between immediate and delayed intent, determining when users are most likely to engage with a service. By dynamically adjusting engagement timing, the system ensures that recommendations and interactions are delivered at the most effective moment, improving overall engagement rates.

Systems and methods further dynamically analyze multiple types of user activity, process data in real-time, and adapt to behavioral changes to improve prediction accuracy. By integrating telecom-specific data with machine learning techniques that can capture evolving user behavior, embodiments provide a more comprehensive and adaptive approach to predicting user interest in various services while also optimizing engagement strategies.

In a feature and advantage of embodiments, user interest prediction utilizing real-time behavioral data for tailored recommendations includes the use of telecom-specific data sources (such as SMS logs, call logs, push notifications, email interactions and broader website visit data). In another feature and advantage of embodiments, Word2Vec embeddings and domain clustering are integrated to improve accuracy by grouping similar behavioral patterns.

In another feature and advantage of embodiments, trend model (e.g. boosted model(s)), Gated recurrent unit (GRU)-based recurrent networks, and deep neural networks (DNNs) are integrated for improved prediction accuracy, thereby providing a more comprehensive approach to real-time updates through continuous model adjustment (in contrast to, for example, static sliding window techniques). GRU networks specialize in identifying temporal patterns, allowing the system to dynamically adapt to changes in user activity over extended periods. In addition to these learning techniques, the system employs a cascading model-ensembling approach to refine predictions at multiple stages. The first-stage model targets users with the highest probability of engagement, providing precise targeting of known behavioral patterns. The second-stage model expands to users with less definitive engagement signals, improving recall while maintaining relevance. A final filtering layer evaluates outliers and adjusts targeting dynamically based on thematic clustering, providing balanced audience selection.

In another feature and advantage of embodiments, the system not only predicts user interest in services but also determines the optimal engagement timing by distinguishing between immediate and delayed intent. This enables personalized and well-timed recommendations, improving engagement effectiveness.

In another feature and advantage of embodiments, user interest in services can be predicted beyond mere advertisement click-through rates, thereby providing a broader application scope compared to existing systems. In another feature and advantage of embodiments, a real-time adaptive framework is introduced, allowing the system to update predictions dynamically when behavioral shifts are detected. By integrating engagement timing optimization alongside thematic interest prediction, the particularly unique data source (telecom log) and the application of advanced machine learning models improve both targeting precision and real-time responsiveness. The technical result is a system that delivers accurate, real-time predictions of user interest with a dynamic, adaptive capability while engagement occurs at the most effective moment.

Embodiments address key technical challenges in real-time user interest prediction by introducing a scalable, adaptive platform that efficiently processes large-scale telecommunications data streams. Traditional machine learning models struggle with batch processing limitations and lack the ability to adjust dynamically to evolving user behavior. In contrast, the disclosed system leverages a combination of boosted ensemble models, Gated Recurrent Unit (GRU)-based recurrent networks, and deep neural networks (DNNs) to provide continuous real-time updates, improving accuracy and engagement effectiveness. The platform integrates real-time telecom data streams, including SMS logs, call logs, push notifications, email interactions, and domain visit patterns, ensuring that predictions remain contextually relevant as user behavior shifts. Unlike conventional approaches that rely on static segmentation or rule-based classification, the system dynamically refines predictions based on temporal trends, using trend modeling and cascading ensemble techniques to capture both immediate and long-term user intent. Additionally, computational efficiency is improved through optimized data processing pipelines, reducing latency in high-volume environments while maintaining predictive accuracy. By overcoming the constraints of traditional batch-processing methods, the system provides faster, more precise engagement timing, delivering interactions at the most opportune moment with minimal delay. These technical advancements provide a robust and scalable solution for real-time interest prediction, setting it apart from existing methodologies that fail to adapt to rapid behavioral shifts in telecommunications data.

In an embodiment, a method for real-time predicting user interest in external services based on telecom log data comprises receiving real-time telecom data, wherein the real-time telecom data includes at least one of domain visit logs, SMS logs, push notifications, email interactions or call logs associated with a live user; preprocessing the real-time telecom data to obtain preprocessed data; applying one or more predictive models to generate a user current state prediction using the preprocessed data; applying the one or more predictive models to generate a user trend state prediction using the preprocessed data; applying the user current state prediction and user trend prediction to a unifying model; generating a targeted service prediction, wherein the unifying model determines both a probability of successful engagement and a specific time based on the combined user state prediction and the user trend state prediction.

In an embodiment, a system for real-time predicting user interest in external services based on telecom log data comprises at least one processor; and memory operably coupled to the at least one processor including instructions that, when executed, cause the at least one processor to execute: receive real-time telecom data, wherein the real-time telecom data includes at least one of domain visit logs, SMS logs, push notifications, email interactions or call logs associated with a user, preprocess the real-time telecom data to obtain preprocessed data, apply one or more predictive models to generate a user current state prediction using the preprocessed data; apply the one or more predictive models to generate a user trend state prediction using the preprocessed data, apply the user current state prediction and user trend prediction to a unifying model, and generate a targeted service prediction, wherein the unifying model determines both a probability of successful engagement and a specific time based on the combined user state prediction and the user trend state prediction.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system of prediction of user interest in services based on telecommunications data, according to an embodiment.

FIG. 2 is a functional block diagram of a system of prediction of user interest in services based on telecommunications data, according to an embodiment.

FIGS. 3A-3B are a sequence diagram of a method of prediction of user interest in services based on telecommunications data, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

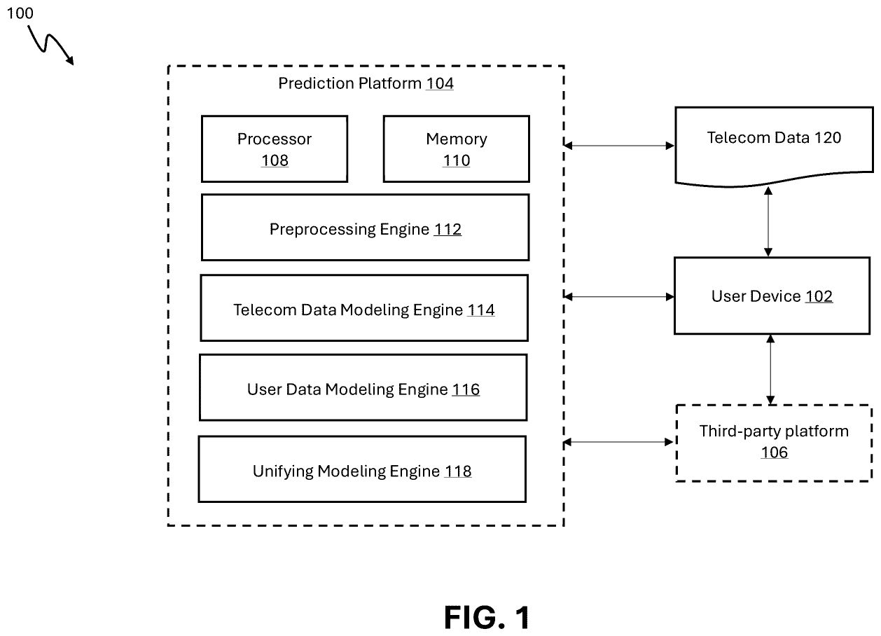

Referring to FIG. 1, a block diagram of a system 100 of prediction of user interest in services based on telecommunications data is depicted, according to an embodiment. System 100 generally comprises a user device 102 and a prediction platform 104. In one aspect, system 100 further optionally comprises a third-party platform 106.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), or Graphic Processing Unit (GPU), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

User device 102 comprises a computerized device for receiving and sending telecommunications data 120. For example, user device 102 can comprise a computerized device operable by a user and can be a desktop computer, laptop computer, tablet, mobile computing device, server, workstation, Internet-of-things device, or other computing device. User device 102 can further comprise many computing devices operably coupled by a network (though a user may interact with only one such computing device).

In one aspect, telecommunications data 120 is generated by user device 102 interaction with networked telecommunications services or telecommunications devices and comprises at least one of a domain visit log, an SMS log, push notifications, email interactions, or call logs associated with a user. Telecommunications data 120 can be generated in real-time, can comprise historical telecommunications data, or can comprise real-time and historical data. In one aspect, user device 104 further generates user data, or other data associated with a user of user device 102.

In one aspect, user device 102 further generates user data, which includes demographic, behavioral, and contextual information that supplements telecommunications data 120. While telecommunications data 120 captures network-based activity such as domain visits, SMS logs, push notifications, email interactions, and call records, user data provides additional context about the user's preferences and characteristics. This can include geolocation data (e.g., GPS-based coordinates, frequently visited locations), demographic attributes (e.g., age, gender, language preferences), long-term interests (e.g., service usage trends, financial preferences), and device metadata (e.g., device type, operating system, network provider). By integrating these supplementary data points, the system can refine predictions by incorporating broader user context, enabling a more personalized and context-aware approach to determining user interest in various services.

In another embodiment, user data may be provided by a telecommunications operator or an advertiser. Telecom operators can supply aggregated demographic and behavioral insights based on network activity, while advertisers can contribute engagement metrics, user preferences, and interaction histories from digital marketing campaigns. This externally sourced user data can be integrated alongside device-generated and telecom-based data to further improve predictive accuracy and improve targeted service recommendations.

In an embodiment, telecommunications data 120 includes improved feature representations, such as domain embeddings derived using an embedding generator (for example, Word2Vec), enabling deeper contextual analysis of user interests than traditional machine learning systems.

Prediction platform 104 generally comprises a processor 108, memory 110, a preprocessing engine 112, a telecommunications data modeling engine 114, a user data modeling engine 116, and a unifying modeling engine 118.

Processor 108 can be a programmable device that accepts digital and/or analog data as input, is configured to process the input according to instructions or algorithms and provides results as outputs. In an embodiment, processor 108 can be a central processing unit (CPU) configured to carry out the instructions of a computer program or several computer programs.

Memory 110 can comprise volatile or non-volatile memory as required by the coupled processor 108 to not only provide space to execute the instructions or algorithms, but to provide the space to store the instructions themselves. In embodiments, memory 110 can further comprise temporary storage for data related to system 100. In an embodiment, processor 108 can utilize instructions stored in memory 110, that when executed by processor 108, cause processor 108 to implement the engines of prediction platform 104.

In an embodiment, system 100 presents a real-time event processing framework that enables immediate updates to the predictive models based on detected user activity changes. When a user performs an action, such as visiting a new domain, sending an SMS, or initiating a call, the system triggers an event-based learning mechanism. This mechanism allows for immediate re-evaluation of the user's engagement score, leading to adaptive changes in model predictions. This engagement score is a multi-dimensional metric combining, for example, a success probability (a percentage value indicating the likelihood of a positive engagement outcome), a service type identifier (specifying the service category associated with prior engagements), and a user identifier (a unique, anonymized value linking the score to the individual's behavioral history). For example, if a user who typically engages with financial services suddenly begins interacting with e-commerce sites, the system dynamically adjusts the weighting of financial versus retail interest classifications in the unifying model. The recalculated engagement score is updated in real-time as new data is received, with older interactions decaying in influence compared to recent, high-impact activities.

In an embodiment, system 100 presents a real-time event processing framework that supports immediate updates to the predictive models when user activity changes are detected. When a user performs an action—such as visiting a new domain, sending an SMS, or initiating a call—the system triggers an event-based learning mechanism that recalculates the user's engagement score. This engagement score is a multi-dimensional metric combining, for example, a success probability (a percentage value indicating the likelihood of a positive engagement outcome), a service type identifier (specifying the service category associated with prior engagements), and a user identifier (a unique, anonymized value linking the score to the individual's behavioral history). If a user typically interacting with financial services begins to show activity in e-commerce, the system adjusts the weightings of the corresponding service categories in the unifying model. The recalculated engagement score is updated in real-time as new data is received, with older interactions decaying in influence compared to recent, high-impact activities.

Preprocessing engine 112 comprises instructions to pre-process telecommunications data 120. In one aspect, preprocessing engine 112 can be configured for converting raw telecom logs into structured telecom data segmented by user. Preprocessing engine 112 extracts and structures time-series features for predictive modeling. The extracted features include time_diff (interval between user actions), week (segmenting monthly activity patterns), trig (indicating that a user has visited a domain), sms (flagging that an SMS related to an offer was received), email (flagging that an email related to an offer was received), push notification (flagging that an push notification related to an offer was received), click (indicating that the user clicked on an offer received in SMS/email/push notification), action (signifying that the user performed an action after clicking the offer, such as visiting a website or completing a transaction), cluster (site cluster ID), and domain_emb (Word2Vec domain embeddings representing visited domains). These features enable the system to recognize both short-term and long-term behavioral patterns, improving interest classification accuracy. In one aspect, preprocessing engine 112 can be configured for preprocessing telecom data by smoothing time-series data to account for variations in user activity. A raw telecom log is presented below as Table 1.

TABLE 1

| msisdn | domain | timestamp |
|---|---|---|
| user_id_1 | site_1.com | 1717954222 |
| user_id_2 | site_1.com | 1719423032 |

Additionally, preprocessing engine 112 implements domain embedding and clustering techniques. To improve user behavior prediction, the system processes historical domain visits using a sliding time window approach, capturing sequences of visited domains over several hours. Based on these sequences, an embedding model is trained to generate domain embeddings, allowing for a continuous vector representation of domain relationships. Once embeddings are obtained, domains are clustered based on similarity, reducing the overall domain space into a manageable number of groups while preserving their contextual relevance. This clustering technique enables the system to generalize user interest beyond individual domain occurrences and improves the accuracy of service predictions.

Telecommunications data modeling engine 114 comprises instructions to implement one or more machine learning models based on telecommunications data 120. For example, telecommunications data modeling engine 114 can implement a GRU-based trend model for sequential pattern detection, a current user state model, or other model(s). GRU networks are particularly well-suited for capturing dependencies in time-series telecom data, enabling refined long-term behavior analysis. As another example, telecommunications data modeling engine 114 can implement a trend model for telecommunications data 120, a current user state model, or other model(s). In an embodiment, telecommunications data modeling engine 114 is configured to train its model(s) using known telecommunications data and optionally user data. In one aspect, the models of telecommunications data modeling engine 114 are individually weak learners.

User data modeling engine 116 comprises instructions to implement one or more machine learning models based on user data. For example, user data modeling engine 116 can implement a user data encoding model. In an embodiment, user data modeling engine 116 is configured to train its model(s) using known user data and optionally known telecommunications data. In one aspect, the model(s) of user data modeling engine 116 are individually weak learners.

Unifying modeling engine 118 aggregates predictions from multiple sources and can be implemented using various machine learning methods, including ensemble learning techniques (e.g., boosting, random forests) and deep neural networks.

In an embodiment, unifying modeling engine 118 comprises instructions to implement a boosted ensemble model. In an embodiment, unifying modeling engine 118 further comprises a deep neural network (DNN). In aspects, a boosted ensemble model identifies simple patterns using multiple weak learners, while the DNN detects complex, non-linear relationships. Boosting is an ensemble learning method that combines a set of weak learners into a strong learner to minimize training errors. Boosting algorithms can improve the predictive power of data mining. Together, the boosted ensemble model and DNN offer higher predictive accuracy than traditional systems.

Third-party platform 106 can comprise networked third-party devices or third-party networks themselves. In embodiments, third-party platform 106 comprises networked interaction with user device 102, such as to present computerized advertisements, or collect or generate user data. In an embodiment, third-party platform 106 can itself implement one or more machine learning models.

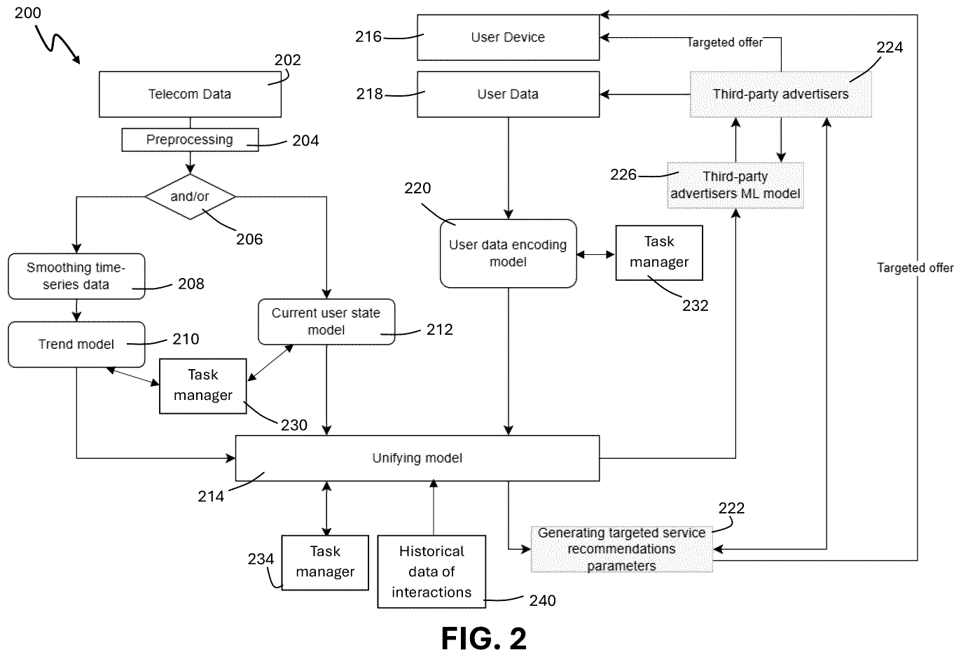

Referring to FIG. 2, a functional block diagram of a system 200 of prediction of user interest in services based on telecommunications data is depicted, according to an embodiment. In an embodiment, system 200 can implement the components of system 100. The components of system 100 would be readily understood by one of ordinary skill in the art in the context of system 200 and are not repeated here for conciseness.

System 200 generally comprises telecom data 202. In an embodiment, telecom data 202 is received directly from a telecom provider, where it is generated in real-time based on network activity. This data includes domain visit logs, SMS logs, push notifications, email interactions, and call metadata, which are collected from telecommunications infrastructure without requiring interception at the user device level.

For example, telecom data 202 can include at least one of domain visit logs, SMS logs, push notifications, email interactions, or call logs associated with a user. Accordingly, telecom data 202 is gathered according to user interaction data from telecom operators, which forms the basis for understanding user behavior. In one aspect, input includes raw telecom logs including a time, domain name, SMS content, and call metadata, etc. In one aspect, output includes structured telecom data segmented by user, with fields including user_id, domain, datetime stamp, and call/SMS metadata. For example, when a user visits the domain example.com at 15:34 on 2024 Sep. 5, sends/receives SMS, and makes calls, such data is captured in the log. In embodiments, raw telecom logs can be processed or preprocessed to convert to structured telecom data as described above.

User data 218, on the other hand, provides complementary data to telecom data 202, capturing static attributes such as demographic characteristics and long-term interests. Both telecom data 202 and user data 218 undergo separate preprocessing stages before being fed into their respective machine learning models. For example, referring again to system 100, telecom data modeling engine 114 is trained on behavioral signals extracted from network logs, while user data modeling engine 116 encodes structured user attributes. The unifying model 214 integrates outputs from both models to generate a holistic prediction of user interest score and the best time for interaction.

However, obtaining and processing telecom logs presents several challenges. Telecom operators follow strict data privacy and compliance regulations, which may limit access to certain user activity records, requiring appropriate data anonymization and aggregation. To address this, the system operates within the telecom operator's infrastructure, ensuring that all data remains anonymized and is processed in a secure environment. Additionally, telecom logs are often generated in large volumes and at high velocity, making real-time processing computationally demanding. The system mitigates this by focusing only on the relevant user segment, significantly reducing the volume of data that needs to be processed in real-time. The diversity in data formats across different operators also requires custom pipelines for parsing and structuring the logs, as there is no universal standard for telecom event recording. To handle this, preprocessing is tailored for each telecom operator, accounting for specific data structures and operational differences to ensure compatibility. Finally, raw telecom data may contain noise, incomplete records, or inconsistencies due to network conditions, necessitating preprocessing steps such as deduplication, timestamp alignment, and anomaly detection before the data can be reliably used for predictive modeling.

In an embodiment, target resources for which the telecom data is derived can be selected. In one aspect, domains and alpha-names of the target resources are initially selected from a specific thematic category, and each domain is evaluated for relevance to the one or more predictive models based on a conversion rate. Additional related domains can be automatically added based on thematic similarity.

The selection process follows a structured pipeline to optimize the predictive quality of telecom data. Initially, a list of candidate domains is derived from high-engagement thematic categories (e.g., financial services, e-commerce, or subscription-based platforms). These domains undergo an evaluation phase where conversion rates, historical engagement metrics, and frequency of user interactions are analyzed. The system ranks the most relevant domains based on their predictive contribution to past successful recommendations.

Once high-relevance domains are identified, an automated expansion mechanism leverages thematic similarity to include additional related domains. The similarity assessment is based on Word2Vec embeddings, clustering techniques, and expert-defined taxonomy models, ensuring that domains within related interest groups are considered for analysis. This allows the model to generalize across service types while maintaining domain specificity, improving classification accuracy.

In one aspect, monitored resources are continuously reassessed based on real-time feedback data. If a domain exhibits declining conversion performance, it is deprioritized, while domains demonstrating strong engagement trends are elevated within the ranking system. This dynamic selection process ensures that the predictive model adapts in real-time to changing user behaviors and emerging service trends.

For SMS and call log-based resource selection, a similar approach is applied. Alpha-names associated with high-conversion user interactions are prioritized, with expansion mechanisms adding related communication identifiers based on contextual engagement patterns. This holistic resource selection framework significantly improves the model's ability to refine service recommendations and predict user intent with greater precision.

In an embodiment, the target resource selection process further leverages domain clusters generated from Word2Vec embeddings. By way of explanation, word embedding is a language modeling technique for mapping words to vectors of real numbers. It represents words or phrases in vector space with several dimensions. Word embeddings can be generated using various methods like neural networks, co-occurrence matrices, probabilistic models, etc. Accordingly, Word2Vec comprises models for generating word embedding. These models are shallow two-layer neural networks having one input layer, one hidden layer, and one output layer. Word2Vec therefore allows words to be represented as vectors in a continuous vector space. In particular, Word2Vec maps words to high-dimensional vectors to capture the semantic relationships between words.

In addition to Word2Vec-based clustering, clusters may also be formed based on frequency of user interactions, conversion rates, and other engagement metrics. This allows for the identification of high-value resources that may not have strong semantic similarities but exhibit common patterns in user behavior. By incorporating multiple clustering criteria, the system improves its ability to group resources that are likely to yield higher engagement, even in cases where embeddings alone may not fully capture their relevance.

Initially, a list of domains is determined based on thematic categories. Then, weightings are applied based on their historical impact on successful interactions. To improve the selection process, domains that preceded high-value interactions are prioritized, and additional domains are identified based on clustering similarity scores. By analyzing clusters instead of individual domain names, the system dynamically expands its selection criteria to include semantically similar domains, increasing prediction robustness and reducing dependency on manually curated domain lists.

Automating the selection of relevant domains for analysis ensures that only high-conversion domains are used in the model, which improves the accuracy of predictions. The inclusion of related domains expands the scope without diluting relevance. In one aspect, a list of domains or alpha-names from a specific category (e.g., financial services), along with their conversion rates are utilized as an initial input. In one aspect, a refined list of high-relevance domains, including additional thematically related domains identified through expert or automated analysis results from the target resource selection. For example, domains related to microloans are automatically selected based on high conversion rates, and additional domains related to interest rates or financial services are included to broaden the predictive scope.

In an embodiment, initially, a list of domains can be determined from a known list. Next, weightings are considered for domains that preceded successful and unsuccessful interactions. This approach is used to expand the list of domains. Upon additional request, all domains that preceded the interaction are loaded for some users. This is done separately for successful and unsuccessful interactions. The users for this operation are selected so that they reflect the largest part of all users. To do this, users with median activity are taken. Next, the most frequent domains are selected from the received domains (for example, the top 1000) and a weight of evidence is calculated for each of them. Then a decision is made to add them to the list of monitored domains.

At 204, system 200 conducts preprocessing (or further preprocessing, in embodiments). At 206, preprocessing 204 can implement one or more features (e.g. 208, 210 and/or 212) For example, at 204, preprocessing can include preprocessing telecom data 202 by smoothing time-series data 208 to account for variations in user activity, such that the time-series data is segmented into predefined intervals. In one aspect, statistical features including number of clicks on one or more monitored resources, number of unique sites visited on one or more monitored resources, and average number of clicks on one or more monitored resources over a predefined time period are calculated.

The selection of resources to be monitored is based on conversion rates, thematic relevance, and user engagement metrics. Initially, domains, alpha-names (for SMS interactions), and call patterns are chosen from specific categories relevant to predictive modeling (e.g., financial services, e-commerce, or subscription-based services). These selections are validated based on historical user interaction data, where higher conversion rates indicate stronger relevance to user interest prediction. Additionally, embodiments can employ automated expansion mechanisms that identify related domains and communication identifiers based on thematic similarity. If a monitored resource consistently correlates with user engagement, it remains in the dataset, while those with low relevance or minimal interactions are deprioritized. This dynamic selection process allows the system to continuously refine monitored resources based on real-time user behavior trends.

Feature extraction further includes generating domain embeddings using embedding models (for example Word2Vec models) trained on sequences of domain visits within predefined time windows. By representing domains as continuous vectors, the system captures contextual relationships between different websites, allowing it to group similar behaviors across users. Following embedding generation, a clustering mechanism categorizes domains into a fixed set of groups, optimizing feature representation for machine learning models. This enables the prediction system to recognize high-conversion domains and apply insights from similar domains when analyzing user interest.

Accordingly, preprocessing 204 normalizes data to remove noise and outliers that could distort a prediction model's output. Smoothing and segmenting the data helps to analyze trends and patterns over time. In an embodiment, a moving average can be used for smoothing.

In one aspect, raw, unstructured telecom data that varies in frequency (e.g., spikes in activity on certain days) is converted to preprocessed and structured time-series data that can be analyzed, including fields such as n_clicks, n_sites, and rolling averages over one or more predefined intervals. For example, if a user visited 5 unique sites with 10 clicks in one day, with an average of 7 clicks over the last 14 days, preprocessing 204, determines n_clicks=7, n_sites=5, and rolling average=7/14 days. In one embodiment, weights at different ends of the sliding window can be added so that some values have more weight than others. In further embodiments, an upper limit on the indicators can be added; or example, if a user visited 15 sites of the same topic per day, then it is already possible to make an assumption about user interest, and further values may already be redundant.

At 204, preprocessing 204 incorporates real-time event triggers that adjust model predictions dynamically. When a new telecom event occurs (e.g., an SMS is received, a call is made, or a new domain is visited), the current user state model 212 immediately evaluates whether this action constitutes a behavioral shift. In response to these triggers, a short-term model recalculates engagement likelihood scores before sending updated user profiles to unifying model 214. This approach reduces prediction lag, allowing the system to react promptly to shifts in user behavior. For example, if a user receives multiple SMS messages from financial institutions within a short timeframe, the system may increase the probability of interest in loan-related services and prioritize those recommendations in real-time. Conversely, if engagement with financial services declines, the system adapts by reducing exposure to financial offers.

Though not depicted in FIG. 2, telecom data can be collected from multiple telecom operators and preprocessing 204 can include normalization of the data from multiple operators for analysis by the deep neural network and boosted models. In one aspect, telecom data from different operators may vary in format or granularity, so normalization provides consistent input to the models. In an input to normalization, telecom data from multiple sources (e.g., different telecom operators), and output comprises normalized data that conforms to a unified format for analysis. For example, normalizing click data across different regions or telecom providers can guarantee fair comparisons and reliable predictions. More particularly, users in one region may be more interested in a given offer. This does not mean that they should not be sent to another region at all. This means that the “interested user” needs to be redefined for each region in order to evaluate each user fairly.

In an embodiment, the system 200 processes telecom data 202 from multiple operators. While telecom data 202 formats may differ across providers, the system operates on atomic event data, which does not require extensive normalization. Instead, data is structured into a standardized format for consistency in analysis without modifying its fundamental properties. Different telecom operators can provide data in varying formats-some may offer explicit domain visit logs, while others may group data into predefined categories instead of providing individual website details. To handle this variability, preprocessing modules within the system adapt to each operator's data structure. These modules account for format-specific constraints while keeping the output consistent for predictive modeling. For example, user state assessment models (e.g., UserState Well) generate probability scores on a standardized scale (e.g., between 0 and 1), regardless of the operator-specific input format. Similarly, clustering, embedding, and other feature extraction techniques are applied independently within each telecom operator's dataset, allowing localized processing while keeping a unified structure in the final analysis. If necessary, minor adjustments are applied to align different data structures, but raw event records remain intact to preserve accuracy.

In one aspect, preprocessing 204 normalization interfaces with the predictive model(s) to determine the desired data formats. For example, if the predictive model(s) accept only data fields, preprocessing 204 converts the received data into the form familiar to the model.

The system includes multiple machine learning models working together, including a trend model 210 (capturing long-term behavioral patterns), a current user state model 212 (assessing short-term behavioral shifts), and a unifying model 214 (integrating multiple predictive streams for final classification).

In an embodiment, a trend model 210 can be trained based on trends and patterns determined from smoothing time-series data 208. The training process incorporates structured time-series features to improve predictive accuracy. The extracted feature set includes time_diff for tracking action frequency, week for periodicity analysis, and categorical flags such as trig, sms, click, and action to differentiate event types. Additionally, cluster (a categorical feature grouping websites into predefined categories based on user transition patterns, popularity, or structural similarity) and domain_emb (a numerical vector representation of domains generated using embedding techniques such as Word2Vec, capturing contextual relationships between visited websites) features provide semantic representation of visited domains, aiding in user behavior segmentation. These engineered features are critical in both boosted ensemble models and deep neural networks (DNNs), allowing models to detect recurring activity trends and adapt to evolving user engagement.

In an embodiment, trend model 210 is trained to recognize patterns in user activity over time by analyzing preprocessed time-series data 208. The trend model is designed to detect long-term behavioral patterns and may be implemented using one or more machine learning techniques, including ensemble learning (e.g., gradient boosting, decision trees) or deep learning-based approaches such as recurrent neural networks and transformers. In an embodiment, the trend model incorporates boosted ensemble methods (e.g., Random Forest, CatBoost) and/or deep learning models (e.g., deep neural networks, DNNs) to detect both simple and complex behavioral trends in telecommunications data.

In an embodiment, the trend model 210 also identifies time-based patterns in user interactions. If a user consistently engages on specific days or hours (e.g., every Tuesday at 9 PM), the model incorporates this into its predictions. For example, if a user frequently interacts with financial services on weekends, the system will prioritize engagement during these periods rather than randomly selecting any available time.

At its core, the boosted ensemble model identifies statistical correlations between user actions and interest in services. This model combines multiple weak learners (e.g., decision trees) to create a stronger predictor, allowing it to capture recurring behavioral signals such as repeated visits to financial service websites or frequent SMS interactions with specific alpha-names. The DNN further refines these predictions by learning non-linear dependencies and extracting higher-order behavioral relationships that may not be evident in traditional models.

The training phase of trend model 210 involves feeding trend model 210 preprocessed time-series data segmented by predefined intervals (e.g., 7-day, 14-day, and 21-day windows), including features such as: n_clicks—the number of clicks on monitored resources, n_sites—the number of unique websites visited, rolling averages—smoothed activity trends over different time frames, visit frequency metrics—recurrence patterns in user engagement, communication signals—SMS/call metadata correlated with service-related interactions.

By leveraging boosted ensemble models to establish a strong baseline and DNNs to capture deeper behavioral structures, trend model 210 allows the system to detect early signals of user interest shifts, refine service recommendations, and adapt to evolving behavior in real-time.

In an embodiment, trend model 210 dynamically provides feedback to preprocessing engine 112 to optimize event selection and reduce unnecessary processing overhead. Traditional systems process all incoming telecom events, leading to excessive computational demands and inefficiencies. By contrast, the disclosed system leverages historical behavior patterns and long-term engagement trends identified by trend model 210 to filter incoming telecom data before the incoming telecom data is passed to current user state model 212 for real-time evaluation. Trend model 210 analyzes longitudinal user behavior, identifying high-confidence patterns that indicate sustained interest in specific services. Based on this analysis, it provides a prioritization signal to preprocessing engine 112, enabling the system to selectively process only high-relevance telecom events. For example, if a user consistently engages with financial services during specific time windows, the system prioritizes telecom events related to financial domains during those periods while deprioritizing unrelated triggers.

In an embodiment, preprocessing engine 112 applies an adaptive thresholding mechanism informed by trend model 210. This mechanism establishes event thresholds based on engagement scores, discarding low-confidence triggers that are unlikely to impact user interest predictions. For instance, if a user sporadically visits an e-commerce website but lacks a history of sustained engagement, the system may filter out minor browsing activities while prioritizing more relevant telecom interactions. Additionally, the feedback loop between trend model 210 and preprocessing engine 112 enhances real-time processing efficiency by batching low-priority events instead of processing them individually. This reduces the system's overall computational burden and improves latency for high-priority user interactions. The adaptive nature of this mechanism ensures that preprocessing engine 112 dynamically adjusts event prioritization based on evolving user behavior.

In an embodiment, a current user state model 212 can be trained to evaluate a user's present engagement level and behavioral status based on telecom data 202. Unlike trend model 210, which focuses on long-term behavioral patterns, current user state model 212 assesses real-time user activity to determine whether the user is currently in an active engagement phase, transitioning between interest states, or displaying inactivity.

Current user state model 212 operates by analyzing recent telecom activity, such as the latest domain visits, frequency and timing of SMS interactions, push notifications, email interactions, call logs, and other service engagement indicators. This allows the system to differentiate between users who are actively exploring a service category versus those whose engagement is sporadic or declining. The model segments users based on short-term behavioral changes, considering factors such as sudden increases in activity, recurring interactions with a specific service type, or extended inactivity that may indicate loss of interest.

To maintain adaptability, current user state model 212 continuously updates its predictions as new data arrives. Current user state model 212 is configured to assign a real-time probability score reflecting a user's likelihood of engagement with a particular service. For example, if a user has recently visited multiple financial service domains within a short time frame and has exchanged SMS messages with financial institutions, the model may classify the user as being in a high-interest state for financial services. Conversely, if a user has interacted infrequently or ceased activity, the model may predict a diminishing likelihood of engagement. Current user state model 212 is essential for adaptive targeting and recommendation timing, as it enables the system to determine the optimal moment to present a service recommendation based on a user's current engagement state rather than relying solely on historical behavior trends.

At 214, a GRU-based recurrent network, a boosted ensemble model, and a deep neural network are trained using the preprocessed time-series data 208 to develop a plurality of predictive models for user interest scoring based on real-time data. The predictive models utilize domain embeddings as input features, ensuring that clustering-based generalizations are incorporated into the training process. Word2Vec embeddings allow models to understand relationships between visited websites, providing a structured representation of user behavior. The clustering mechanism further refines these representations, enabling the boosted ensemble model to learn aggregated user interests across domain groups rather than relying solely on individual domain occurrences.

At 214, the unifying model integrates multiple predictive components, including the trend model 210, current user state model 212, user data encoding model 220 and determines the optimal timing for engagement. By analyzing both historical trends and real-time behavioral signals, the unifying model classifies users based on their immediate or delayed engagement intent. This allows the system to adjust when and how recommendations are delivered, improving overall engagement effectiveness. These models, trained on preprocessed time-series data 208, work together to classify user interest in various services using both historical patterns and real-time behavioral insights.

The unifying model 214 employs a multi-stage cascading approach to optimize user selection. Initially, a first-stage model applies a high-confidence filter, selecting users with a strong history of engagement based on prior interactions. The second-stage model expands predictions to a broader audience with moderate confidence scores, capturing additional users with potential interest. Any remaining users undergo a final layer of filtering, which applies thematic relevance checks and additional behavioral weightings to refine the output. This cascading model provides an optimal balance between high-precision targeting and comprehensive audience reach. In embodiments, a first stage completes before a second stage is entered. Similarly, a second stage completes before any subsequent stage is entered. Such staging allows for efficient processing and moreover, captures relevant users in a sequence of high-medium-low confidence to determine the most relevant users.

The unifying model 214 is trained using preprocessed behavioral data to predict both user interest and engagement timing based on past interactions. The training process teaches the model to classify users into immediate and delayed engagement categories, allowing recommendations to be delivered when users are most receptive. For example, training data may reveal that users who frequently interact with a service within a short time frame should receive immediate engagement, while users with sporadic engagement patterns require delayed or follow-up interactions.

Each component plays a distinct role. Trend model 210 captures long-term behavioral patterns by analyzing smoothed time-series data, identifying recurring activity trends over time. In an embodiment, trend model 210 captures long-term engagement preferences, identifying specific time windows and days of the week when users are most responsive. Current user state model 212 processes recent user interactions to assess immediate interest in services, ensuring predictions reflect up-to-date behavior. User data encoding model 220 processes demographic and contextual user attributes, allowing personalization based on individual characteristics. GRU-based learning enables improved time-series forecasting by maintaining memory of prior interactions, allowing the system to detect trends across long-term engagement cycles. The boosted ensemble model detects simple, interpretable behavioral patterns using multiple weak learners. DNN refines predictions by identifying complex, non-linear relationships within the data. To optimize predictive accuracy, unifying model 214 integrates engineered time-series features. Features such as time_diff and week enable time-based segmentation, trig, sms, click, and action flags provide interaction context, and cluster and domain_emb offer a high-dimensional representation of user interests. The combination of these features provides fine-grained behavioral segmentation, improving recommendation precision.

In an embodiment, training on preprocessed (smoothed) data improves prediction accuracy compared to raw data, which often contains sporadic activity spikes and long inactivity gaps. By smoothing data, the system fills in missing values more effectively, improving behavioral trend detection and optimizing the timing of service recommendations.

The unifying model 214 is trained on existing or historical telecom data, including past user interactions, labeled interest categories, and successful conversions. FIG. 2 illustrates the data preprocessing pipeline feeding into the unifying model, capturing both training and real-time data processing, though redundant steps are omitted from the diagram for clarity. Accordingly, at 214, predictive models can recognize user behavior patterns indicative of interest in services. Boosted ensemble model 214 identifies simple patterns using multiple weak learners, while the deep neural network (DNN) detects complex, non-linear relationships. Together, the boosted ensemble model and DNN offer higher predictive accuracy.

In an embodiment, training on pre-processed (smoothed) data operates better than on raw data because in the case of learning from original data, rare peaks of activity and the complete absence of any actions in between are observed. In such conditions, it is often quite difficult for models to make predictions. Therefore, by applying data smoothing to reasonably fill in the gaps, patterns of user behavior are better identified in order to make an offer on time.

In one aspect, input to unifying model 214 includes preprocessed time-series data segmented by intervals (e.g., 7-day, 14-day, and 21-day) with features like: n_clicks (number of clicks); n_sites (number of unique sites visited); rolling averages, visit frequency, and other behavioral statistics. Unifying model 214 can be trained on existing or historical telecom data (past interaction data, labels for user interest, or successful conversions), which can be preprocessed (e.g. smoothed). Thus, FIG. 2 depicts the training data capture and preprocessing to unifying model 214 (e.g. 202-212) as well as test or at-issue data capture and preprocessing (though not repeated in FIG. 2 for ease of illustration).

With further reference to training of the boosted ensemble model and deep neural network using the preprocessed time-series data to develop predictive models for user interest scoring, training ensures that system 200 is capable of recognizing patterns in user behavior that are indicative of interest in specific services. The boosted ensemble model (e.g., Gradient Boosting, Random Forest) serves as an effective initial learner, capturing a variety of patterns. The deep neural network (DNN) further refines predictions by modeling more complex, non-linear relationships in the data.

In embodiments, training includes the following sub-operations. In a first sub-operation, data is prepared for training. In one aspect, preprocessed telecom data is split into training, validation, and test sets. In one aspect, data is augmented with labels corresponding to the target service interest classification.

Second, the boosted ensemble model is trained. In one aspect, the boosted ensemble model (e.g., Gradient Boosting, XGBoost, or CatBoost) is trained first to act as a baseline. Hyperparameters (e.g., learning rate, tree depth, number of estimators) can be tuned using cross-validation. The boosted ensemble model is trained to optimize a loss function (e.g., log loss, cross-entropy) to classify user interest levels.

In a third sub-operation, the DNN is trained. In one aspect, the DNN architecture is defined, typically with multiple hidden layers (e.g., fully connected layers) with activation functions (e.g., ReLU, sigmoid) to capture non-linear relationships. The DNN is trained using the same preprocessed data, with outputs from the boosted model optionally provided as an additional input. In one aspect, backpropagation is used to update weights, and a loss function (e.g., cross-entropy) is minimized using a stochastic gradient descent (SGD) optimizer or Adam optimizer. In one aspect, dropout and batch normalization can be applied to prevent overfitting and stabilize training.

Optionally in a fourth sub-operation, the ensemble is integrated. For example, system 200 can combine the predictions of the boosted model and the DNN to improve robustness. In one aspect, ensemble techniques like weighted averaging or stacked generalization (stacking) can be applied.

In a fifth sub-operation, the ensemble is validated and evaluated. In one aspect, model performance is evaluated using standard classification metrics such as: Precision, Recall, F1 Score, Area Under ROC Curve (AUC-ROC), Mean Squared Error (MSE) or Cross-Entropy Loss. In one aspect, the model is tested using previously-unseen data (verify set) to verify generalization. If required, model retraining is triggered for performance improvement.

In a sixth sub-operation, the model is deployed. In one aspect, the final trained models (both boosted and DNN) are saved as serialized objects (e.g., Pickle, ONNX, TensorFlow SavedModel) for use in real-time predictions

Accordingly, output at 214 includes (1) a trained boosted ensemble model and trained DNN for recognizing user interest, and (2) performance metrics (e.g., accuracy, cross-entropy loss, F1 Score, recall, area under the receiver-operating characteristic curve (AUC) that represents the probability that the model, if given a randomly chosen positive and negative example, will rank the positive higher than the negative) for model evaluation. In one aspect, F1 Score is useful in tasks with unbalanced classes. The F1 Score metric combines precision and recall into a single value, which makes it easier to rank models by quality.

In a simple example, the system trains on historical telecom log data, where users with a pattern of visiting certain finance-related domains receive a classification label for “interest in financial services.” The boosted model identifies that users who frequently visit specific financial websites and exhibit n_clicks >20 in the last 14 days have a high likelihood of interest in personal loan services. The DNN further refines this prediction, recognizing that if users also engage in SMS or call activities with banking services, their interest likelihood increases. The combined ensemble system achieves a 90% prediction accuracy for users likely to show interest in financial services.

In one aspect, the predictive model(s) are trained on historical data that includes records of user interactions and cases of successful engagements, allowing the model to determine both overall level of user interest and optimal time for delivering service recommendations. Training the model on historical data that includes successful interactions helps the system learn which patterns are most likely to lead to user engagement, and it also improves the ability to time recommendations effectively. Accordingly, training input can comprise historical data, including past user actions (e.g., clicks, purchases) and outcomes of previous service recommendations (e.g., successful conversions or interactions). The trained model output can therefore predict not only whether a user will be interested in a service but also when the best time to offer the service is. For example, a user's previous interactions with financial services are used to predict that offering a mortgage loan during weekdays results in higher engagement for similar users, optimizing both the timing and content of the recommendation.

In one aspect, historical telecom log data comprises data for multiple users. In one aspect, historical telecom log data comprises data for the specific live user, such that the predictive model(s) and DNN are tailored only to the live user.

Trend model 210 and current user state model 212 serve as distinct yet complementary inputs to the unifying model 214, which synthesizes multiple data streams to generate user interest predictions. Their roles and integration into the unifying model 214 are as follows.

Trend model 210 is trained on smoothed time-series data and captures long-term behavioral patterns in user interactions. It identifies recurring usage patterns, behavioral shifts, and evolving interests based on past data segmented into predefined intervals (e.g., 7-day, 14-day, and 21-day windows). This model provides an aggregate view of user behavior over time, offering insights such as seasonal trends, gradual engagement growth, or sustained high activity levels for particular service categories. The output of trend model 210 is used as feature input to the unifying model, helping to refine predictions by providing insights into how past behavior may influence future interest.

Current user state model 212 focuses on short-term, real-time behavioral signals, analyzing a user's most recent actions to detect immediate engagement levels. It processes recent telecom interactions (e.g., site visits, SMS exchanges, push notifications, email interactions, call patterns) within a much shorter window (e.g., typically 1 to 3 days, depending on system configuration and data availability) to determine immediate intent. In contrast, the trend model 210 analyzes long-term behavioral patterns (e.g. typically spanning 1 to 2 months), to capture recurring activity trends and seasonal variations. These timeframes are adjustable based on data retention constraints and specific use case requirements. This model helps detect spikes in activity or sudden changes that might indicate interest in a specific service at a given moment.

In one aspect, before integration, telecom data 202 is transformed into sequential behavioral patterns using time-series smoothing 208, while user data 218 is structured into categorical and numerical embeddings. The two datasets are initially processed in parallel and later merged into a unified feature space before final classification.

Unifying model at 214 combines outputs from both trend model 210 (long-term behavior) and current user state model 212 (short-term activity) and user data encoding model 220 to create a comprehensive representation of user interest. Unifying model at 214 thus assigns weights to the inputs from both models to ensure that real-time behaviors are prioritized where relevant, while long-term trends remain essential for broader interest prediction. By integrating these models, the unifying model can adapt to new behaviors while retaining an understanding of persistent user preferences, leading to more accurate and context-aware predictions. In an embodiment, classifications can be made, such as for a short term loan; 80% success at the current moment;

Trained unifying model 214 can therefore operate (e.g. used in real-time predictions) on real-time telecom data, which likewise can be preprocessed, smoothed, etc. as in 202-212. In particular, the trained boosted ensemble model and the deep neural network can be applied to real-time telecom data to identify patterns of user behavior indicative of interest in specific services. In one aspect, boosted models provide a strong baseline by capturing weak learners, while a deep neural network refines the prediction by learning complex patterns in user data. In one aspect of the application of trained unifying model 214 to real-time telecom data, input includes preprocessed data segmented by intervals (e.g., 7-day, 14-day, 21-day) including n_clicks, n_sites, and other calculated statistics (e.g. the real-time data is also preprocessed). In one aspect of the application of trained unifying model 214 to real-time telecom data, the real-time data is not preprocessed.

In an embodiment, system 200 implements adaptive recommendation strategies that dynamically adjust recommendations based on user engagement feedback. In one aspect, system 200 tracks user engagement with prior recommendations, including whether the user clicked on, ignored, or rejected an offer. If a lack of interaction is detected within a predefined time window, system 200 reclassifies the user's interest and re-optimizes future recommendations.

In one aspect, system 200 comprises reclassification and re-optimization modules configured to refine prediction accuracy when a recommendation does not result in engagement. If a user does not interact with an initial recommendation within a predefined timeframe (e.g., 24-48 hours), Task manager 234 initiates a retraining process. The retraining process updates the user's interest classification based on short-term and long-term behavioral trends, analyzing the user's most recent interactions across telecom activity and demographic context.

In one aspect, reclassification and service category re-evaluation occur when an initial prediction does not yield engagement. System 200 evaluates alternative service categories by identifying behavioral indicators that more closely align with the user's most recent actions. For example, if a user does not interact with financial service offers but exhibits engagement with e-commerce-related domains, Task manager 234 triggers a category adjustment process that prioritizes shopping or digital payment services.

In an embodiment, system 200 dynamically updates recommendation weights by adjusting the influence of specific feature signals based on past engagement history. Task Manager 230 manages scheduled updates for trend model 210 and current user state model 212, while task manager 232 handles updates for user data encoding model 220. Both task managers 230 and 232 operate independently, ensuring that updates for trend-based predictions and encoding processes are continuously refined based on incoming data. Once these independent updates are complete, task manager 234 initiates retraining of unifying model 214 to integrate the latest updates from the other components. Further, system 200 generates a new optimized offer based on the updated classification and recalibrated feature weights. Additionally, task manager 234 is responsible for communication channel selection. Task manager 234 dynamically selects the optimal communication channel (SMS, push notifications, email, etc.) based on historical user engagement patterns and real-time behavioral feedback. Task manager 234 continuously evaluates real-time and historical user interaction data to determine the most effective communication channel. Task manager 234 can dynamically adjust engagement strategies by considering message opens, clicks, and ignored interactions, ensuring that the most appropriate medium is used for each user. The unifying model 214 supplies engagement probability scores and optimal interaction timing, which task manager 234 integrates into its decision-making process. Task manager 234 governs modifications to communication strategies, including delivery channel selection (e.g., SMS, push notification, email) or adjusting the offer type based on inferred user preferences. For example, a user initially classified as interested in financial services based on prior SMS exchanges with banks may receive a credit card offer. If the user does not interact with the offer, Task manager 234 reclassifies the user based on recent behavioral signals, such as an increase in e-commerce transactions. System 200 then modifies the next recommendation to focus on shopping rewards or digital wallet promotions to increase engagement probability. By continuously refining recommendations based on engagement patterns, system 200 improves user targeting while reducing redundant or irrelevant offers. In one aspect, this process improves conversion rates and user experience by ensuring service recommendations align more closely with evolving user behavior.

To maximize engagement effectiveness, the system leverages a multi-channel communication framework, dynamically selecting the most effective engagement strategy based on real-time user interactions. This subprocess includes categorizing user responses across different interaction types and refining engagement strategies accordingly.

The system 200 continuously receives real-time user interaction data from multiple communication sources, including SMS, push notifications, emails, and call records. These interactions are processed through a structured event categorization system that differentiates between various types of user engagement signals: trigger events—user-initiated actions, such as website visits or direct searches, which indicate an active interest in a particular service; system events—system-generated engagement attempts, including outgoing SMS messages, push notifications, and email campaigns, aimed at prompting user interaction; click events—user responses to a system-generated event, such as clicking a link in an SMS, push notification, or email, reflecting varying degrees of engagement interest; action events—the final stage of user engagement, where the user completes a transaction, registers for a service, or interacts in a manner that indicates a conversion.

By tracking user response patterns across different channels, the task manager 234 determines which engagement strategy and communication method are most effective for a given user segment. This allows the system 200 to dynamically adjust future interactions, prioritizing the most successful engagement channels while deprioritizing those that yield low response rates. For instance, if a user consistently ignores SMS notifications but engages with push notifications, the system will increase the weight of push notifications for that user while reducing reliance on SMS as a communication method. This real-time adaptability guarantees that engagement remains relevant and optimized based on evolving user behavior.

System 200 follows a scheduled retraining process managed by task managers 230, 232, and 234. Task managers 230 and 232 perform updates independently, refining trend model 210, current user state model 212, and user data encoding model 220 based on new behavioral data. Once individual model updates are completed, task manager 234 synchronizes retraining for unifying model 214, integrating the latest refinements from the independently updated models.

Additionally, task manager 234 monitors anomalies and performs model validation checks to prevent data drift or population shifts. If deviations exceed predefined thresholds, they trigger a partial retraining process or issue alerts for further review before deploying updated models. These updates may be executed based on regulatory schedules or triggered dynamically by detected behavioral anomalies.

In one aspect of the application of trained unifying model 214 to real-time telecom data, output includes prediction of user interest based on patterns identified in the data. In a simple example, users who visit certain financial services websites with high frequency over a 21-day window are likely to be interested in financial services.

Further at 214, a prediction of user interest can be generated based on the patterns identified by the ensemble model and deep neural network. Accordingly, the analyzed test data is converted into actionable insights, thereby predicting whether the user is likely to respond to specific services. In one aspect, a prediction is made by input of processed time-series data with identified patterns of behavior (e.g. identified by the model), and a prediction score is output, thereby indicating the likelihood of user interest in certain services (e.g., “User has a 75% chance of being interested in a personal loan offer”).

In an embodiment, user data is further utilized in unifying model 214. For example, system 200 can further comprise user device 216. User data 218 is generated based on user interaction with user device 216 (such as personal information, authentication information, device information, setting information, user preferences, demographic information, location information, etc.) In one aspect, a user data encoding model 220 is generated based on user data 218. Accordingly, unifying model 214 can be supplemented with data (converted to a model) such as geolocation, gender, age, and long-term interests.

More particularly, supplementing the telecom data with user data 218 improves the accuracy of user interest predictions. Supplementing telecom data with additional user demographic and behavioral attributes (such as geolocation and age) provides a complete user profile. This helps make personalized and accurate predictions based on broader context about the user. In one aspect, refined predictions therefore account for both telecom activity and demographic or long-term interest factors. For example: a 30-year-old male in a specific geographic area showing interest in financial services would receive more targeted offers based on both his telecom activity and demographic profile.

In an embodiment, in weighing telecom data versus supplemental user information when making predictions, the model separately analyzes user activity data, and then these results are transmitted further. In a next step, the model uses the previously obtained outputs and additional information to make a final prediction.

In an embodiment, task manager 234 generates targeted service recommendation parameters, including communication channel selection, engagement scenarios, offer personalization, and delivery timing, based on predictions of user interest, historical data, and behavioral trends. These parameters guide the selection of the most effective engagement strategy tailored to individual users.

Task manager 234 can generate targeted service recommendation parameters for telecom operator 302, allowing the delivery of telecom-driven engagement campaigns. Embodiments determine the optimal engagement method, which may include SMS, push notifications, voice calls, or interactive telecom services (e.g., USSD, RCS, IVR prompts), optimizing for both delivery reliability and user responsiveness.

At step 338, Telecom operator 302 receives the targeted service recommendation parameters from Task manager 234 and processes them into personalized service offers for user device 304. The telecom operator may adapt offer formats and delivery channels based on network-specific constraints and subscriber preferences.

In another embodiment, task manager 234 can directly generate the targeted offer and transmit it to telecom operator 302, which then applies format adjustments, compliance checks, and scheduling optimizations before delivering the message to the user.

Telecom operator 302 may apply its own machine learning models to refine targeting parameters, rank users based on network usage trends, or adjust delivery prioritization based on real-time telecom events (e.g., user is currently active on the network). However, task manager 234 remains the primary decision-making component, continuously adjusting recommendations in response to user engagement feedback.

In an embodiment, task manager 234 optimizes engagement timing by analyzing historical telecom interaction patterns, identifying preferred engagement windows (e.g., a user engaging more frequently with telecom messages at specific times of the day or in response to particular events). Based on these insights, telecom operator 302 schedules message delivery at the most relevant moment, improving response rates and overall effectiveness.

At 222, system 200 further comprises generating targeted service recommendations parameters (e.g. communication channel, scenarios (including ML models that can be used by the customer), offers and content of the service recommendations) based on prediction of user interest, historical data and behavior data.

From 222, a targeted offer can be provided directly to user device 216 using the targeted service recommendations parameters. In another aspect, from 222, the targeted service recommendations parameters can be provided to third-party advertisers 224, which can utilize a third-party advertisers ML model 226 to generate the targeted offer. In an embodiment, as illustrated, unifying model 214 can be utilized as an input to third-party advertisers ML model 226.

In an embodiment, system 200 provides a targeted service recommendations from third-party advertisers (e.g. from 222 directly or via 224) to user device 216 based on the prediction, thereby applying the predictions in a real-world environment. And more particularly, delivering actionable recommendations directly to users. In one aspect, input at 222 is prediction scores from unifying model 214 and output (via 222 or 224) is personalized service recommendations sent to users in real-time (e.g., “Offer a mortgage loan to User A”). For example: A user who frequently visits financial websites receives an offer for a mortgage, based on the model's prediction.

At 228, unifying model 214 can be retrained. In one aspect, unifying model 214 can be retrained on previously-real-time data (e.g. data applied to unifying model 214 after initial training) to determine a service recommendation. Successful results or unsuccessful results of a previously-sent offer (e.g. from real-time data) can be utilized to retrain unifying model 214 to more particularly capture a given user.

The unifying model 214 is retrained periodically to improve the accuracy of both user interest and engagement timing predictions. Over time, the system learns from past engagement success rates, refining its ability to determine whether a user should receive immediate, scheduled, or delayed engagement. For example, if historical data shows that engagement effectiveness improves when certain user segments receive interactions later in the day, the model will adjust timing predictions accordingly in future interactions.

In an embodiment, unifying model 214 is retrained weekly. Because users are gradually changing, telecom data does not immediately reflect user changes. Accordingly, a weekly retraining period will capture changes (in view of processing requirements for retraining) but not so much that the model starts to make big mistakes in its predictions. In other aspects, unifying model 214 is retrained every 10 days, every 7 days, every 5 days, every 3 days, or every day.

In another embodiment, retraining of unifying model 214 is dynamically triggered based on predefined thresholds, ensuring that the model remains adaptive to changing user behaviors. Retraining occurs when one or more of the following conditions are met: a sudden drop in conversion rates (e.g., a decrease of more than 15% over a rolling 7-day period); an increase in failed recommendations (e.g., a rise in rejected or ignored offers beyond an acceptable threshold); the detection of new behavioral clusters, where user activity deviates significantly from previously established patterns; a significant decline in model performance metrics such as precision, recall, or F1-score, signaling the need for an updated model; seasonal variations or emerging trends detected in user engagement, requiring model adjustments. Retraining frequency can be further adjusted based on the volume of new user interactions, guaranteeing that updates occur when meaningful behavioral changes are observed rather than at fixed intervals.

In an embodiment, system 200 (and its associated methods) operates in real-time, thereby updating the user interest prediction continuously as new telecom data is received and processed. Real-time updating ensures the model adapts to changes in user behavior, making recommendations more timely and relevant. Accordingly, upon fresh telecom data, such as new SMS logs, domain visits, and call logs, updated predictions reflecting the most recent user behavior are generated. For example, a user who suddenly starts visiting e-commerce websites after browsing financial ones would receive updated recommendations for a shopping loan.

System 200 therefore enacts a “real-time constraint”, for example from event to system response. In an embodiment, an event is new telecom data received, and the system response is a communication to the relevant user within a certain time threshold. In embodiments, real-time reflects less than 10 minutes, less than 5 minutes, less than 4 minutes, less than 3 minutes, less than 2 minutes, or less than 1 minute. For example, to improve prediction accuracy, the system 200 implements a short delay before finalizing a user's classification. When a trigger event occurs (such as a website visit, SMS interaction, or call), system 200 waits to accumulate additional behavioral signals before processing the final prediction. This provides a more comprehensive user profile analyzation, preventing premature classifications based on isolated actions. However, in one example, a maximum cut-off time can be enforced to maintain real-time responsiveness, typically under 5 minutes for optimal performance. When a new behavioral event occurs, the system updates the user's interest prediction and re-evaluates the optimal engagement timing in real time. For example, if a user begins browsing financial services websites after a period of inactivity, the system may classify this as a sign of renewed intent and schedule engagement sooner. Conversely, if the user demonstrates passive browsing behavior, engagement may be delayed until further interaction signals are detected. This adaptive timing mechanism allows engagement to occur at the most relevant moment, improving the likelihood of successful interaction.

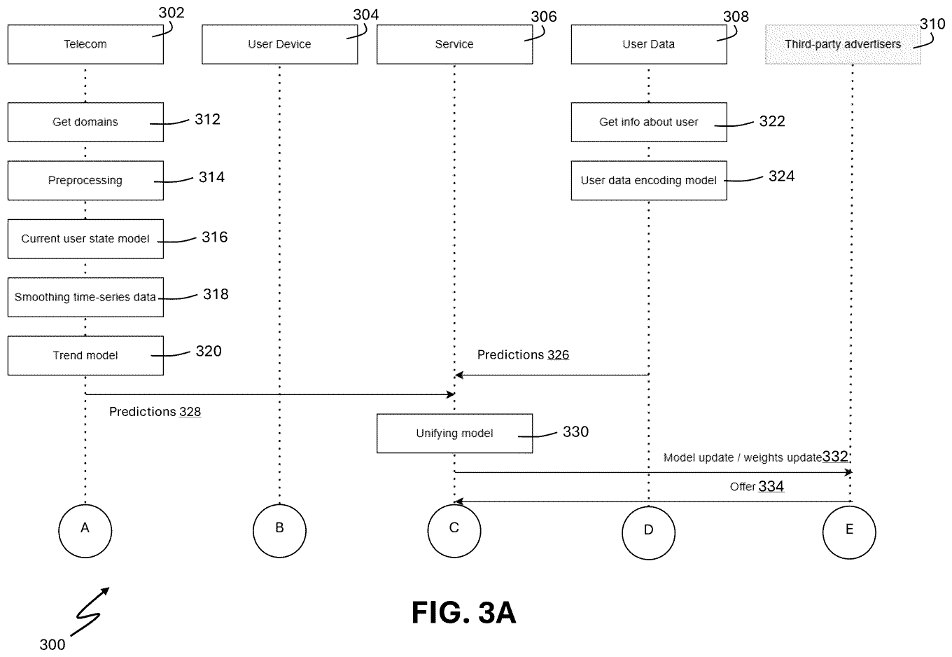

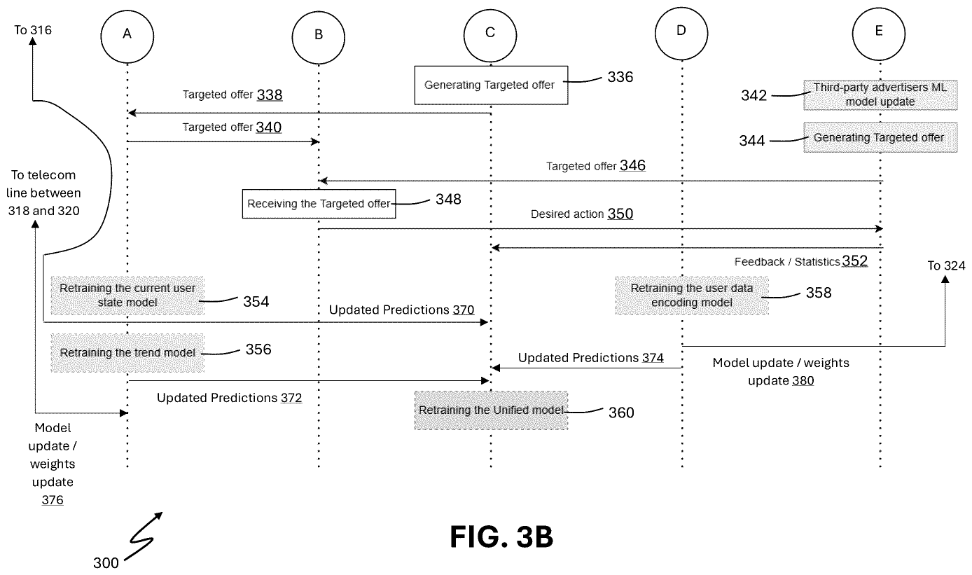

Referring to FIGS. 3A-3B, a sequence diagram of a method 300 of prediction of user interest in services based on telecommunications data is depicted, according to an embodiment. The sequence diagram in FIGS. 3A-3B comprises the following actors: telecom (data) provider 302, user device 304, prediction service 306, user data 308, and third-party advertiser(s) 310.

Method 300 generally comprises, with reference to telecom provider data 302, obtaining relevant domains at 312, preprocessing 314 telecom data of the relevant domains, training a current user state model 316, smoothing time-series data 318, and training a trend model 320.

Method 300 generally comprises, with further reference to user data 308, obtaining information about the user 322, and training a user data encoding model 324.

At 326, using 322-324, predictions related to user data 308 are provided to prediction service 306. At 328, using 302-320, predictions from trend model 320 and current user state model 316 are provided to prediction service 306. Predictions from data at 326 and 328 are combined in the unifying model 330.

At 332, prediction outputs from the unifying model 330 are provided to third-party advertiser 310. At 334, offer data is provided to prediction service 306.

At 336, a targeted offer is generated by prediction service 306. At 336, when a targeted offer is generated by the prediction service 306, real-time updates may modify the offer parameters dynamically. If new telecom data arrives while the offer is pending (e.g., the user engages with a different service type), system 300 can override the initial recommendation and issue an alternative offer better suited to the updated behavior. Furthermore, event-based learning ensures that retraining is not solely reliant on scheduled intervals. If a critical change in user behavior is detected, system 300 can initiate an on-the-fly model update (e.g., by adjusting confidence scores in real-time rather than waiting for the next retraining cycle). When a user's behavior changes, the system updates the predictive model to reflect new engagement patterns and adjust the timing of future interactions accordingly. For example, if a user who was previously classified for immediate engagement suddenly stops interacting, the system may switch to a delayed engagement approach, allowing recommendations to be delivered at a later, more suitable time. This real-time adaptation allows the system to remain responsive to shifting user preferences and behavioral patterns.

At 338, the generated targeted offer is provided to telecom provider 302. In turn, telecom provider 302 provides the targeted offer 340 to user device 304. Telecom provider 302 can adjust the offer format to align with system-specific delivery protocols. In one aspect, the targeted offer can be repackaged by telecom provider 302 according to the particular telecom subsystem.

Optionally at 342, third-party advertiser 310 updates its ML model. At 344, a new targeted offer can be generated. At 346, the new targeted offer is provided to user device 304, which receives the new targeted offer 348 as an interaction with the user.

At 350, a desired action is provided to third-party advertiser 310. At 352, feedback or statistics regarding the new targeted offer can be provided to prediction service 306. Feedback data can include click-through rates, engagement duration, and conversion metrics for further optimization. In embodiments, one or more models can be retrained, such as retraining the current user state model at 354 or retraining the trend model at 356 on the telecom side, or retraining the user data encoding model at 358 on the user data side. Further, the unified model can be retrained at 360.

In embodiments, one or more models can be retrained, such as: retraining the current user state model at 378 and/or retraining the trend model at 376. Retraining the user data encoding model at 380. Updating predictions for the unified model at 370, 372, and 374.

Retraining follows a structured process, where updates from trend model 320 and current user state model 316 are provided to the unifying model 330. Instead of direct weight updates, predictions from retrained models are integrated into the unifying model 330 to refine its recommendation logic.

In an embodiment, method 300 allows for two approaches for retraining models existing prior to the unifying model. One, the entire system can be retrained as a whole or two, individual modules can be updated/retrained as needed, without affecting the others. For example, this can be applied when only current user state model 316 is not performing effectively (e.g. due to becoming outdated).

Though not explicitly illustrated in FIG. 3, method 300 can further detect one or more behavioral shifts in user actions, such as changes in device usage or location, and adapt the prediction model to account for such behavioral changes. User behavior can shift dramatically due to external factors (e.g., device changes or moving locations), which can affect prediction accuracy. Adaptive thresholds within the system detect engagement variations to trigger predictive model adjustments. Adaptive thresholds are based on KPI metrics such as drops in conversion rates, anomalies in system behavior, and engagement fluctuations over predefined periods. For example, if a user's engagement with previously recommended services declines significantly over 24-48 hours, an anomaly is flagged, leading to retraining of the model. Accordingly, input of new/real-time telecom data reflecting changes in user behavior (e.g., a switch from a basic phone to a smartphone) can cause an adjustment to prediction model that adapts to the new behavior (e.g. at 360). For example, unifying model 330 can recognize that a user has switched from occasional browsing to frequent mobile app usage, signaling increased engagement. Behavioral changes are detected using historical trend analysis, real-time anomaly detection, and prediction confidence scores. In one particular example, to identify changes in behavior, unifying model 330 can utilize historical data, anomaly detection, and analysis of erroneous predictions when user information changes.

The unifying model 330 processes supplementary data, including historical interactions, to refine its ability to calculate engagement probability scores and determine engagement timing. Historical interactions comprise prior user responses to service recommendations, engagement outcomes across different communication channels, and variations in interaction frequency over time. The system incorporates these data points to establish trends in user engagement, allowing predictions to reflect both short-term behavioral changes and long-term activity patterns.

The training process integrates outputs from the trend model and current user state model, incorporating engagement probability scores based on prior interactions. The system evaluates previous user actions, including instances where service recommendations were ignored, accepted, or rejected, to generate a refined prediction model. By incorporating historical interaction data, the unifying model 330 is configured to adjust decision-making parameters dynamically based on user activity patterns observed over extended periods.

In an evaluation of the quality of the model evaluations as to profitability, the number of offers sent, and the number of clicks on offers are determined. It is important that all such indicators are high enough. While the model is running, changes in these values are evaluated and the dependence of indicators on incoming information are used to identify the causes of deterioration or sudden changes in values. Additionally, failure patterns in previous predictions are analyzed to refine future offer distribution strategies.

Accordingly, as described herein, embodiments advantageously provide telecom data analysis. In one aspect, the system collects and analyzes telecom log data, including domain visit logs, SMS logs, and call logs associated with a user. This data forms the foundation for user behavior analysis for accurate predictions of interest in external services. In one aspect, the purpose of analyzing telecom data is to build a detailed behavioral profile of users, providing insight into which services might be of interest.

Embodiments further advantageously provide preprocessing of time-series data. In one aspect, telecom data is preprocessed and smoothed to reduce noise and account for variations in user activity. The data is segmented into predefined intervals (e.g., 7 days, 14 days, 21 days), and key statistical features like the number of clicks, unique site visits, and averages over recent days are calculated. Machine learning-based anomaly filtering ensures that outlier activities are properly weighted. Preprocessing guarantees that raw telecom data is normalized, eliminating outliers and making it suitable for analysis by machine learning models.

Embodiments further advantageously provide boosted ensemble models. In one aspect, a boosted ensemble model (e.g., RandomForest, CatBoost) is applied to the preprocessed data to identify initial patterns of user behavior. These models improve prediction accuracy by combining weak learners into a stronger predictive framework. Boosted models provide a reliable baseline for user interest prediction by capturing multiple aspects of user behavior from the telecom data. To further improve prediction robustness, boosted models are deployed within a multi-layered cascading architecture. A first model in the cascade focuses on high-confidence user classification, providing engagement with the most relevant audiences. Subsequent layers broaden the scope of predictions, iteratively expanding the model's reach while maintaining precision through filtering mechanisms. This structured ensembling approach increases overall accuracy and reduces false positives in user interest classification.

Embodiments further advantageously provide a DNN. After an initial analysis by the boosted models, a DNN is used to refine the prediction. The DNN learns complex, non-linear relationships in the data, identifying more nuanced patterns of user behavior that can indicate interest in specific services. Trend model 210 also leverages self-attention mechanisms to track sequential dependencies in user behavior. In one aspect, the DNN improves the accuracy of the predictions by capturing deeper, more complex insights into user behavior than traditional systems.

Embodiments further advantageously provide a prediction of user interest. In one aspect, embodiments generate a user engagement prediction based on the outputs of the boosted models and the DNN. This prediction indicates the likelihood that a user is interested in specific external services. Converting the analyzed data into actionable predictions allows for personalized service recommendations.

Embodiments further advantageously provide real-time data processing. In one aspect, embodiments operate in real-time, continuously updating the interest predictions for a user as new telecom data is received. This provides timely and relevant recommendations to the user's current behavior. In one aspect, real-time processing ensures that the system adapts to changing user behavior, delivering up-to-date recommendations. Real-time inference pipelines are optimized using distributed computing frameworks for latency reduction.

Incorporating domain embeddings and clustering enables the system to adapt dynamically to new behavior patterns. As new domain visits occur, the embedding generation model (for example, Word2Vec model) places them within the existing embedding space, allowing the system to infer their similarity to known high-conversion domains. This ensures that users who engage with newly visited but contextually similar domains receive accurate interest predictions in real-time, improving response times for targeted service recommendations.

Embodiments further advantageously provide behavioral shift detection. In one aspect, embodiments can detect shifts in user behavior, such as changes in device usage or location, and adapt the predictive models accordingly. This dynamic adjustment maintains prediction accuracy even when the user's habits change. In one aspect, adapting to behavioral shifts ensures that the system remains responsive to the user's evolving behavior patterns. An adaptive decay factor is applied to historical data to prioritize recent behavioral trends in model adjustments.

Embodiments further advantageously supplement with additional user information. Embodiments can supplement telecom data with additional user information, such as geolocation, gender, age, and long-term interests. These supplementary data points are used to improve the accuracy of the predictions by considering broader context about the user. In one aspect, incorporating additional demographic and behavioral attributes leads to more personalized and context-aware predictions.

Embodiments further advantageously provide training on historical data. In one aspect, unifying model (e.g. predictive model) is trained on historical data, including records of user interactions and cases of successful engagements. This training allows the model to learn from past behavior and identify patterns that are most likely to lead to future user engagement. In one aspect, historical training ensures that the model can predict not only the user's general interest but also the optimal time to deliver recommendations.

Embodiments further advantageously provide target resource selection. In one aspect, embodiments automate the selection of domains and alpha-names from a specific thematic category. Domains are selected based on conversion rates, and additional related domains are automatically included based on thematic similarity determined through expert or automated analysis. In one aspect, automating the selection of high-conversion domains ensures that the system focuses on the most relevant resources, improving the quality of predictions.

1. A method for real-time predicting user interest in external services based on telecom log data, the method comprising:
receiving first real-time telecom data from a first telecom operator within infrastructure of the first telecom operator, wherein the first real-time telecom data includes a first data type of at least one of domain visit logs, SMS logs, push notifications, email interactions or call logs associated with a live user;
receiving second real-time telecom data from a second telecom operator within infrastructure of the second telecom operator, wherein the second real-time telecom data includes a second data type of at least one of domain visit logs, SMS logs, push notifications, email interactions or call logs associated with a live user, wherein the second telecom operator is different than the first telecom operator and the second data type is different than the first data type;
preprocessing the first real-time telecom data within the infrastructure of the first telecom operator from the first data type to a standardized event format and preprocessing the second real-time telecom data within the infrastructure of the second telecom operator from the second data type to the standardized event format to obtain preprocessed data, wherein the preprocessing of the first real-time telecom data and the second real-time telecom data respectively includes:
deduplicating the real-time telecom data to remove at least one duplicate record,
time-series smoothing the real-time telecom data using a moving average over a sliding window,
segmenting the real-time telecom data into a predefined interval, and
extracting a feature set including an interval between user actions, a user click indicator, a user action, a domain cluster identifier, and a domain embedding;
applying one or more predictive models to generate a user current state prediction of short-term user intent using the preprocessed data in a first time window;
applying the one or more predictive models including a gated recurrent unit (GRU)-based recurrent network that implements a trend model to generate a user trend state prediction of at least one recurring user activity pattern using the preprocessed data in a second time window, the second time window having a longer timeframe than the first time window;
applying the user current state prediction and user trend prediction to a unifying model, wherein the unifying model comprises a boosted ensemble model and a deep neural network (DNN);
generating a targeted service prediction, wherein the unifying model determines both a probability of successful engagement and a specific time based on the combined user state prediction and the user trend state prediction for one or more users, including:
executing a first-stage high-confidence filter to target a first plurality of users,
executing a second-stage moderate-confidence filter to add at least one user to the plurality of users to generate a second plurality of users, and
executing a thematic relevance filter to the second plurality of users to select the one or more users; and
executing a feedback loop using the one or more predictive models to filter subsequent real-time telecom data according to an adaptive threshold prior to preprocessing the subsequent real-time telecom data.

2. The method of claim 1, wherein time-series smoothing the real-time telecom data accounts for variations in user activity, wherein the time-series is segmented into predefined intervals.

3. The method of claim 1, wherein the one or more predictive models comprises a current user state model.

4. The method of claim 1, further comprising training the trend model using the preprocessed data to develop the one or more predictive models for user trend state prediction using the preprocessed data.

5. The method of claim 3, further comprising training the current user state model using the preprocessed data to develop one or more predictive models for user current state interest prediction using the preprocessed data.

6. The method of claim 3, further comprising training the current user state model using the preprocessed data to develop one or more predictive models for preferred engagement windows prediction, including specific days and time slots of heightened user responsiveness.

7. The method of claim 3, further comprising training the unifying model based on predictions generated by the trend model and the current user state model and supplementary data including historical interactions.

8. The method of claim 3, further comprising training the current user state model using the preprocessed data and supplementary data including historical interactions to develop one or more predictive models for analyzing recent user interactions across multiple communication channels.

9. The method of claim 3, wherein the trend model analyzes historical user interest patterns and predicts optimal engagement timing by identifying recurring time slots of user activity.

10. The method of claim 1, further comprising training a user data encoding model as at least one of the one or more predictive models for user demographic and contextual user attributes using user data from one or more user devices, wherein the unifying model is trained based on the user data encoding model.

11. The method of claim 1, wherein second stage moderate confidence filter is lower than the first-stage high-confidence filter.

12. The method of claim 1, wherein wherein the preprocessing of the first real-time telecom data and the second real-time telecom data respectively further includes applying noise reduction techniques.

13. A system for real-time predicting user interest in external services based on telecom log data, the system comprising:
at least one processor; and
memory operably coupled to the at least one processor including instructions that, when executed, cause the at least one processor to execute:
receive first real-time telecom data from a first telecom operator within infrastructure of the first telecom operator, wherein the first real-time telecom data includes a first data type of at least one of domain visit logs, SMS logs, push notifications, email interactions or call logs associated with a user,
receive second real-time telecom data from a second telecom operator within infrastructure of the second telecom operator, wherein the second real-time telecom data includes a second data type of at least one of domain visit logs, SMS logs, push notifications, email interactions or call logs associated with a live user, wherein the second telecom operator is different than the first telecom operator and the second data type is different than the first data type,
preprocess the first real-time telecom data within the infrastructure of the first telecom operator from the first data type to a standardized event format and preprocess the second real-time telecom data within the infrastructure of the second telecom operator from the second data type to the standardized event format to obtain preprocessed data, wherein the preprocessing of the first real-time telecom data and the second real-time telecom data respectively includes:
deduplicating the real-time telecom data to remove at least one duplicate record,
time-series smoothing the real-time telecom data using a moving average over a sliding window,
segmenting the real-time telecom data into a predefined interval, and
extracting a feature set including an interval between user actions, a user click indicator, a user action, a domain cluster identifier, and a domain embedding,
apply one or more predictive models to generate a user current state prediction of short-term user intent using the preprocessed data in a first time window,
apply the one or more predictive models including a gated recurrent unit (GRU)-based recurrent network that implements a trend model to generate a user trend state prediction of at least one recurring user activity pattern using the preprocessed data in a second time window, the second time window having a longer timeframe than the first time window,
apply the user current state prediction and user trend prediction to a unifying model, wherein the unifying model comprises a boosted ensemble model and a deep neural network (DNN), and
generate a targeted service prediction, wherein the unifying model determines both a probability of successful engagement and a specific time based on the combined user state prediction and the user trend state prediction for one or more users, including:
executing a first-stage high-confidence filter to target a first plurality of users,
executing a second-stage moderate-confidence filter to add at least one user to the plurality of users to generate a second plurality of users, and
executing a thematic relevance filter to the second plurality of users to select the one or more users; and
execute a feedback loop using the one or more predictive models to filter subsequent real-time telecom data according to an adaptive threshold prior to preprocessing the subsequent real-time telecom data.

14. The system of claim 13, wherein time-series smoothing the real-time telecom data accounts for variations in user activity, wherein the time-series is segmented into predefined intervals.

15. The system of claim 13, wherein the one or more predictive models comprises a current user state model.

16. The system of claim 13, wherein the instructions that, when executed, cause the at least one processor to further train the trend model using the preprocessed data to develop the one or more predictive models for user trend state prediction using the preprocessed data.

17. The system of claim 15, wherein the instructions that, when executed, cause the at least one processor to further train the current user state model using the preprocessed data to develop one or more predictive models for user current state interest prediction using the preprocessed data.

18. The system of claim 15, wherein the instructions that, when executed, cause the at least one processor to further train the current user state model using the preprocessed data to develop one or more predictive models for preferred engagement windows prediction, including specific days and time slots of heightened user responsiveness.

19. The system of claim 13, wherein the instructions that, when executed, cause the at least one processor to further train the unifying model based on predictions generated by the trend model and the current user state model and supplementary data including historical interactions.

20. The system of claim 15, wherein the instructions that, when executed, cause the at least one processor to further train the current user state model using the preprocessed data and supplementary data including historical interactions to develop one or more predictive models for analyzing recent user interactions across multiple communication channels.
